(19) United States
(12) Patent Application Publication
(10) Pub. No.: US 2022/0175613 A1
(43) Pub. Date: Jun. 9, 2022

(54) Beverage-Retaining Sexual Device

(71) Applicant: Micah Woolley, Beverly, MA (US)

(72) Inventor: Micah Woolley, Beverly, MA (US)

(21) Appl. No.: 17/163,143

(22) Filed: Jan. 29, 2021

Related U.S. Application Data
(63) Continuation-in-part of application No. 29/760,882, filed on Dec. 4, 2020.

(51) Int. Cl. A61H 19/00; A47G 19/22; A47G 23/02

(52) U.S. Cl. CPC A61H 19/50; A47G 19/2227; A61H 2201/1652; A61H 2201/163; A61H 2201/165; A47G 23/02

(57) ABSTRACT

A beverage-retaining sexual device is an apparatus that has a tapering end which can be inserted into a sexual partner as a means of providing stimulation. A flange section connected to a thinner neck area prevents undesirable penetration depth, while simultaneously providing a grip by which a user may grasp the present invention during sexual activity. The thinner neck area provides an intuitive grasping location during consumption of beverages, especially alcoholic beverages. A protruding ring serves as the rim of the beverage receptacle portion of the apparatus and may take any of a variety of shapes. The beverage receptacle, or shot glass, may be of any depth or volume. The apparatus may further be integrated into a garment or clothing item, such as underwear or a harness, thus facilitating different types of sexual activities. These pieces enable users to use one device to both consume beverages and perform sexual activities.

The current application is a continuation-in-part (CIP) application of the U.S. design application Ser. No. 29/760,882 filed on Dec. 4, 2020.

### FIELD OF THE INVENTION

The present invention relates generally to a sexual instrument. More specifically, the beverage-retaining sexual device is an insertable tool with a hollowed out opening into which beverages may be poured and subsequently consumed. The present invention is also configured to prevent undesirable incidents from occurring during use.

### BACKGROUND OF THE INVENTION

Sexual expression is a key component of any healthy romantic relationship. Partners in such a relationship each have their own set of preferences, acceptable behaviors, and hard rules in order to engage in maximally-pleasurable sexual activity. Demonstrating respect for a romantic partner's wishes is a vital application of communication skills. To help sexual partners fully express and enjoy themselves, a variety of tools have been developed. These tools span across a wide variety of different insertable devices, lubricants, binding tools, and more, each serving its own purpose in stimulating a partner. Such tools allow partners to connect in ways that they otherwise could not. To this end, sexual tools are always advancing and developing to meet the needs and desires of an increasingly creative audience.

However, such tools have yet to fully encapsulate the full breadth of desires of sexual partners. Many such partners enjoy combining alcoholic beverages with their encounters, often as a means of relaxing physically or socially. Consuming alcohol with a penetrative device itself would help to lighten the mood before engaging in more advanced physical sexual activity. Unfortunately, there are no devices which adequately enable partners to engage in penetrative sexual activity and alcoholic consumption simultaneously; these actions are generally performed entirely separately. What is needed is an insertable device capable of both enhancing or contributing to safe sexual engagement between partners and providing the ability to consume a beverage, especially an alcoholic beverage, before or during intercourse.

The present invention addresses these issues. The beverage-retaining sexual device has a tapering end which can be inserted into a sexual partner as a means of providing stimulation. A flange section connected to a thinner neck area prevents undesirable penetration depth, while simultaneously providing a grip by which a user may grasp the present invention during sexual activity. The thinner neck area also provides an intuitive grasping location during consumption of beverages, especially alcoholic beverages. A protruding ring serves as the rim of the beverage receptacle portion of the present invention and may take any of a variety of shapes. The present invention may further be integrated into a garment of piece of clothing, such as underwear or a harness, thus facilitating different types of sexual activities.

### BRIEF DESCRIPTION OF THE DRAWINGS

FIG. 1 is a top perspective view of the present invention.

FIG. 2 is a front view of the present invention.

FIG. 3 is a cross sectional view of the present invention about line 3,4-3,4 in FIG. 2.

FIG. 4 is a cross sectional view of the present invention about line 3,4-3,4 in FIG. 2 showing a pelvic support.

FIG. 5 is a top perspective view of a pelvic support harness of the present invention.

FIG. 6 is a top perspective view of a pelvic support underwear of the present invention.

### DETAILED DESCRIPTION OF THE INVENTION

All illustrations of the drawings are for the purpose of describing selected versions of the present invention and are not intended to limit the scope of the present invention.

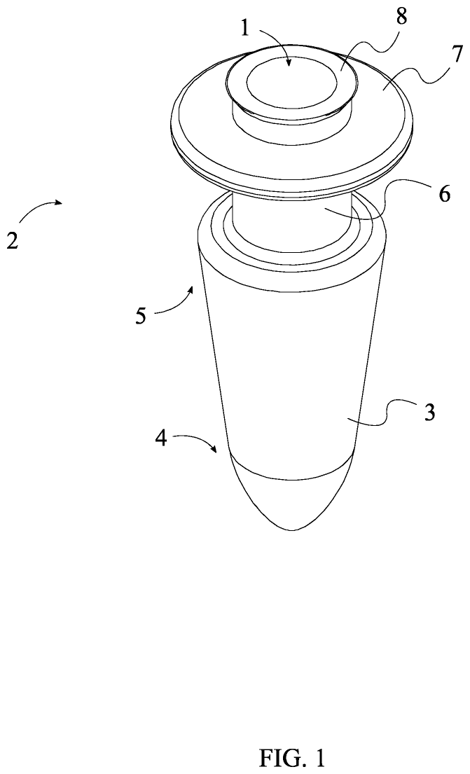

The present invention is a beverage-retaining sexual device that is used as a sexual stimulant during sexual activity. The present invention is also configured to temporarily retain liquids for consumption, preferably before or during sexual activity. The present invention may comprise a beverage cavity 1 and a plug body 2, as shown in FIG. 1. The beverage cavity 1 is the space within the plug body 2 available for the retention and subsequent dispensation of liquids. In a preferred embodiment, the beverage cavity 1 is a shot glass made of semirigid vulcanized polymeric materials or high durability glass, which will not break or shatter under tension; however, it is to be understood by a professional in the field of the present invention that a variety of shapes of different depths, as well as many different materials, may be used in providing an adequate beverage-retaining space within the present invention, and the preferred embodiment is not meant to be limiting. The plug body 2 relates to the volume occupied by the present invention. In a preferred embodiment, the plug body 2 is made of semirigid vulcanized polymeric materials, which will not break or shatter under tension; however, it is to be understood by a professional in the field of the present invention that a variety of different materials may be used in providing an adequate beverage-retaining space within the present invention, and the preferred embodiment is not meant to be limiting.

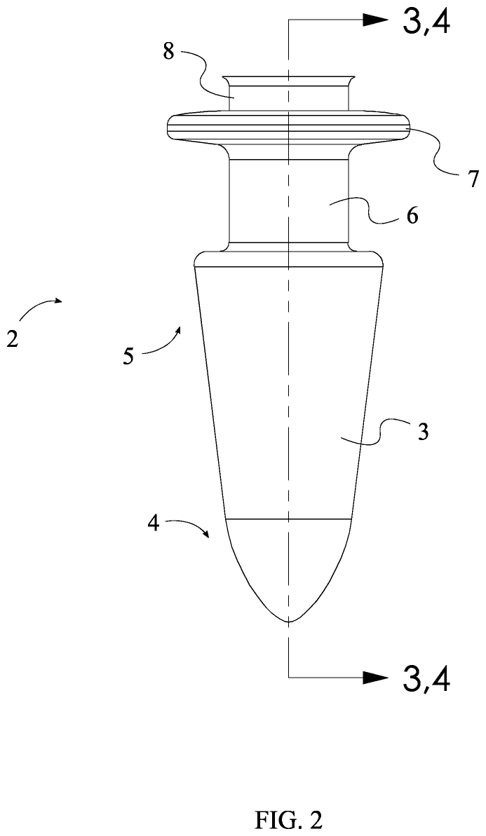

The general configuration of the aforementioned components allows the present invention to efficiently and effectively both retain liquid and be used as a sexual stimulant device. The plug body 2 may comprise an insertable portion 3, a neck portion 6, a flange portion 7, and a stem portion 8, as shown in FIG. 2. The insertable portion 3 is the segment of the present invention which, in the preferred usage of the present invention, is inserted into a sexual partner as a stimulant. In a preferred embodiment, the insertable portion 3 is in a generally conical shape; however, it is to be understood by a professional in the field of the present invention that a variety of different shapes may be advantageous in providing sexual stimulation, and the preferred conical arrangement is not meant to be limiting. The neck portion 6 is a generally narrower cylindrical unit which allows the user to grasp the present invention during use, especially during use as a drinking device. The flange portion 7 denotes a disk-shaped extrusion which provides an intuitive grip for the user, especially while engaging in sexual activity. The stem portion 8 is the segment of the plug body 2 which, in the preferred usage of the present invention, is used as the rim of the beverage cavity 1.

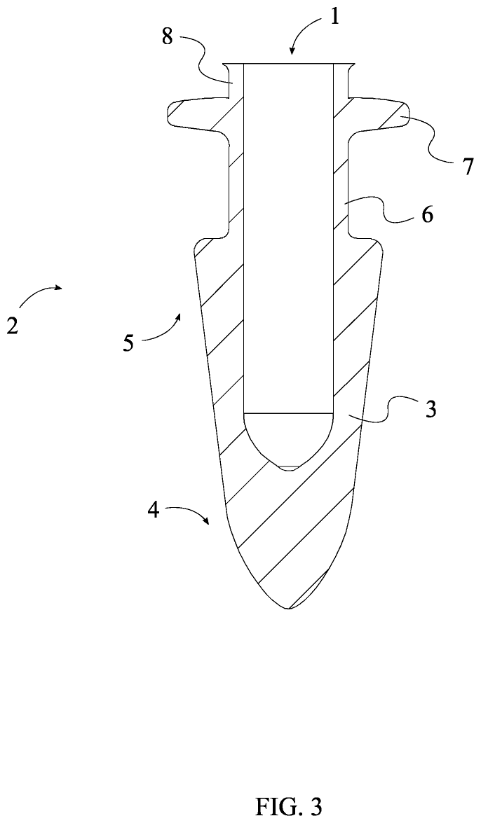

The base components of the present invention enable easy and intuitive application by an end user or users. The insertable portion 3 is connected adjacent to the neck portion 6. This arrangement allows movement of the neck portion 6 to generate a corresponding movement of the insertable portion 3. The flange portion 7 is positioned normal to the neck portion 6. In this way, the neck portion 6 is appropriately oriented to prevent the present invention from travelling too far into a bodily cavity. The flange portion 7 is connected adjacent to the neck portion 6, opposite to the insertable portion 3. This allows movement of the flange portion 7 to control the position of the insertable portion 3, while simultaneously establishing the neck portion 6 as the primary recipient of compressive and extensive forces between the flange portion 7 and the insertable portion 3. The stem portion 8 is positioned collinear to the neck portion 6. This arrangement ensures ample available volume for the beverage cavity 1 in different configurations, and simultaneously facilitates cleaning of the beverage cavity 1. The stem portion 8 is connected adjacent to the flange portion 7, opposite to the neck portion 6. In this way, the stem portion 8 is positioned opposite the insertable portion 3 along the plug body 2. The beverage cavity 1 traverses into the plug body 2 from the stem portion 8, as shown in FIG. 3. Thus, the beverage cavity 1 aligns with the stem portion 8, making consumption more intuitive for a user.

In order to ensure ease of use, the insertable segments of sexual insertable devices often adhere to certain shapes by convention, such as elongated cylinders, conical shapes, and more. To this end, the insertable portion 3 may comprise a first portion end 4 and a second portion end 5, as shown in FIG. 1. The first portion end 4 is the segment of the insertable portion 3 which, in the preferred usage of the present invention, is distal from a user's hand. The second portion end 5 is the segment of the insertable portion 3 which, in the preferred usage of the present invention, is proximal to a user's hand. The first portion end 4 is positioned offset from the neck portion 6. Thus, the first portion end 4 is optimally positioned for insertion during sexual activity. In a preferred embodiment, the first portion end 4 may be rounded; however, there are many possible arrangements for the first portion end 4, and the preferred rounded arrangement is not meant to be limiting. The second portion end 5 is positioned adjacent to the neck portion 6. In this way, the position of the second portion end 5 may be adjusted through modification of the position of the neck portion 6. The insertable portion 3 tapers from the second portion end 5 to the first portion end 4. This arrangement results in a generally conical shape for the insertable portion 3 that may be familiar to different sexual partners.

A user of the present invention benefits from ample surface area against which to operate the insertable portion 3 by using the flange portion 7. To this end, a lateral perimeter of the flange portion 7 may be an oblong shape. In this way, an optimal amount of surface area may be achieved without disrupting the user's ability to grasp the flange portion 7 in a single hand.

A user may wish to consume a larger amount of fluid than would be available from a shot glass volume of space. To accommodate for this, the beverage cavity 1 may traverse through the stem portion 8, through the flange portion 7, through the neck portion 6, and into the insertable portion 3. In this way, larger amounts of beverages may be retained without impeding either the drinking function or the sexual stimulation function of the present invention.

It is possible that a user may wish to store or consume a beverage with the present invention while performing sexual activity. To this end, a central lengthwise axis of the beverage cavity 1 may be oriented at an angle with a central lengthwise axis of the plug body 2. In this way, the beverage cavity 1 may be used both as a sexual stimulant and as a beverage receptacle while minimizing the potential for spillage.

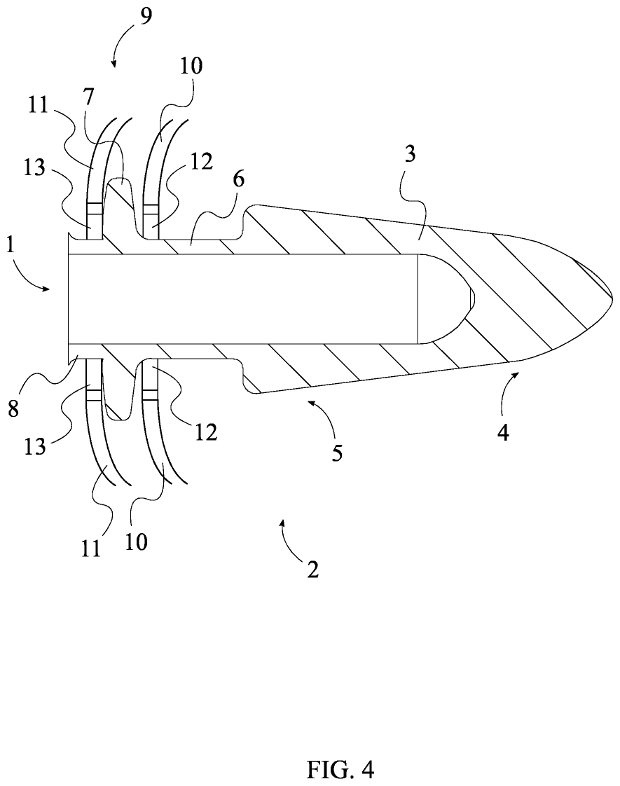

In many uses of the present invention, a user may desire to stimulate their partner in a hands-free manner. To enable this, the present invention may further comprise a pelvic support 9, as shown in FIG. 4. The pelvic support 9 relates to a garment or general wearable apparatus that enables the user to temporarily attach the plug body 2 to the user. The pelvic support 9 comprises a proximal fabric piece 10, a distal fabric piece 11, a proximal O-ring 12, and a distal O-ring 13. The proximal fabric piece 10 denotes a segment of garment preferably made of textile, leather, or other such wearable material which, in the preferred usage of the present invention, is in contact with a user's body. Similarly, the distal fabric piece 11 denotes a segment of garment preferably made of textile, leather, or other such wearable material which, in the preferred usage of the present invention, is separated from the user's body by the proximal fabric piece 10. The proximal O-ring 12 is a preferably rigid annular unit which provides a mounting mechanism for the plug body 2 within the proximal fabric piece 10. Similarly, the distal O-ring 13 is a preferably rigid annular unit which provides a mounting mechanism for the plug body 2 within the distal fabric piece 11. The proximal fabric piece 10 and the distal fabric piece 11 are sandwiched together. In this way, the pelvic support 9 provides a garment that is effectively two-layered. The proximal O-ring 12 is integrated into the proximal fabric piece 10. Thus, the proximal O-ring 12 allows a user to connect items through the proximal fabric piece 10. The distal O-ring 13 is integrated into the distal fabric piece 11. Thus, the distal O-ring 13 allows a user to connect items through the distal fabric piece 11. The flange portion 7 is positioned in between the proximal fabric piece 10 and the distal fabric piece 11. This arrangement enables the user to temporarily secure the plug body 2 in place between the proximal fabric piece 10 and the distal fabric piece 11. The neck portion 6 is positioned through the proximal O-ring 12. In this way, the neck portion 6 ensures appropriate arrangement of the plug body 2 relative to the pelvic support 9. The stem portion 8 is positioned through the distal O-ring 13. Thus, the stem portion 8, and consequently, the insertable portion 3, extends generally towards the user's body.

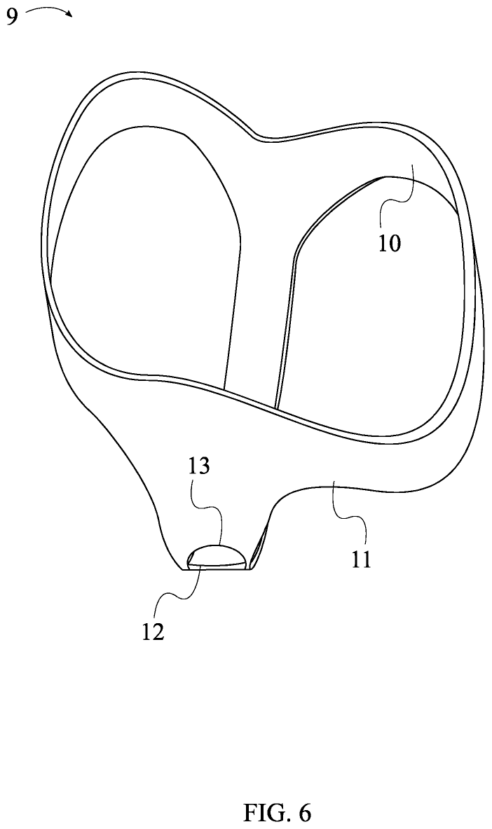

The user of the present invention may desire to incorporate the present invention into a standard undergarment. To this end, the pelvic support 9 may be an underwear, as shown in FIG. 6. This arrangement ensures that the pelvic support 9 may be worn intuitively and comfortably by a user.

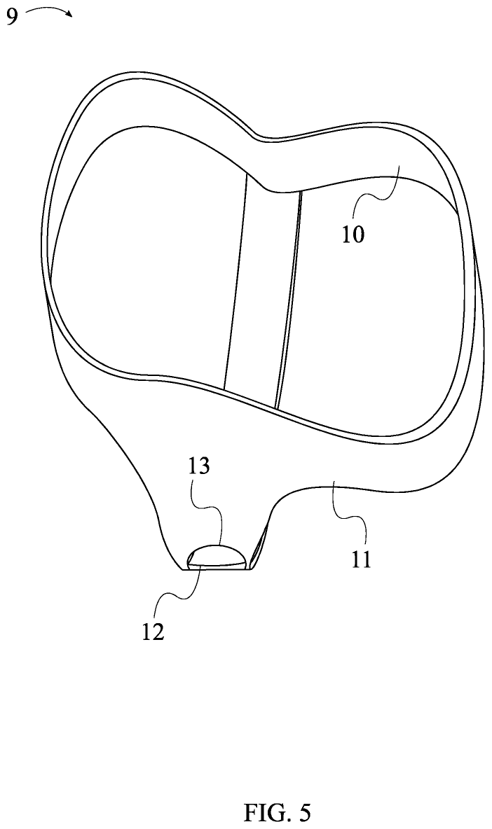

It may also be desirable to utilize the present invention in conjunction with other devices. To facilitate this, the pelvic support 9 may be a harness, as shown in FIG. 5. This arrangement enables the user to integrate the present invention more easily into a variety of other tools, enabling intimate scenarios that are otherwise difficult to accomplish.

A user of the present invention may further desire to utilize the pelvic support 9 atop other units of clothing. To provide for this, the proximal fabric piece 10 and the distal fabric piece 11 may be made of a stretchable fabric material. This arrangement improves the ability of the user to position the plug body 2 in different positions or atop other clothing.

Although the invention has been explained in relation to its preferred embodiment, it is to be understood that many other possible modifications and variations can be made without departing from the spirit and scope of the invention as hereinafter claimed.

What is claimed is:

1. A beverage-retaining sexual device comprises:
a beverage cavity;
a plug body;
the plug body comprises an insertable portion, a neck portion, a flange portion, and a stem portion;
the insertable portion being connected adjacent to the neck portion;
the flange portion being positioned normal to the neck portion;
the flange portion being connected adjacent to the neck portion, opposite to the insertable portion;
the stem portion being positioned collinear to the neck portion;
the stem portion being connected adjacent to the flange portion, opposite to the neck portion; and
the beverage cavity traversing into the plug body from the stem portion.

2. The beverage-retaining sexual device as claimed in claim 1 comprises:
the insertable portion comprises a first portion end and a second portion end;
the first portion end being positioned offset from the neck portion;
the second portion end being positioned adjacent to the neck portion; and
the insertable portion tapering from the second portion end to the first portion end.

3. The beverage-retaining sexual device as claimed in claim 1, wherein a lateral perimeter of the flange portion is an oblong shape.

4. The beverage-retaining sexual device as claimed in claim 1 comprises:
the beverage cavity traversing through the stem portion, through the flange portion, through the neck portion, and into the insertable portion.

5. The beverage-retaining sexual device as claimed in claim 1 comprises:
a central lengthwise axis of the beverage cavity being oriented at an angle with a central lengthwise axis of the plug body.

6. The beverage-retaining sexual device as claimed in claim 1 comprises:
a pelvic support;
the pelvic support comprises a proximal fabric piece, a distal fabric piece, a proximal O-ring, and a distal O-ring;
the proximal fabric piece and the distal fabric piece being sandwiched against each other;
the proximal O-ring being integrated into the proximal fabric piece;
the distal O-ring being integrated into the distal fabric piece;
the flange portion being positioned in between the proximal fabric piece and the distal fabric piece;
the neck portion being positioned through the proximal O-ring; and
the stem portion being positioned through the distal O-ring.

7. The beverage-retaining sexual device as claimed in claim 6, wherein the pelvic support is an underwear.

8. The beverage-retaining sexual device as claimed in claim 6, wherein the pelvic support is a harness.

9. The beverage-retaining sexual device as claimed in claim 6, wherein the proximal fabric piece and the distal fabric piece are made of a stretchable fabric material.

10. A beverage-retaining sexual device comprises:
a beverage cavity;
a plug body;
a pelvic support;
the plug body comprises an insertable portion, a neck portion, a flange portion, and a stem portion;
the pelvic support comprises a proximal fabric piece, a distal fabric piece, a proximal O-ring, and a distal O-ring;
the insertable portion being connected adjacent to the neck portion;
the flange portion being positioned normal to the neck portion;
the flange portion being connected adjacent to the neck portion, opposite to the insertable portion;
the stem portion being positioned collinear to the neck portion;
the stem portion being connected adjacent to the flange portion, opposite to the neck portion;
the beverage cavity traversing into the plug body from the stem portion;
the proximal fabric piece and the distal fabric piece being sandwiched against each other;
the proximal O-ring being integrated into the proximal fabric piece;
the distal O-ring being integrated into the distal fabric piece;
the flange portion being positioned in between the proximal fabric piece and the distal fabric piece;
the neck portion being positioned through the proximal O-ring; and
the stem portion being positioned through the distal O-ring.

11. The beverage-retaining sexual device as claimed in claim 10 comprises:
the insertable portion comprises a first portion end and a second portion end;
the first portion end being positioned offset from the neck portion;
the second portion end being positioned adjacent to the neck portion; and
the insertable portion tapering from the second portion end to the first portion end.

12. The beverage-retaining sexual device as claimed in claim 10, wherein a lateral perimeter of the flange portion is an oblong shape.

13. The beverage-retaining sexual device as claimed in claim 10 comprises:
the beverage cavity traversing through the stem portion, through the flange portion, through the neck portion, and into the insertable portion.

14. The beverage-retaining sexual device as claimed in claim 10 comprises:
a central lengthwise axis of the beverage cavity being oriented at an angle with a central lengthwise axis of the plug body.

15. The beverage-retaining sexual device as claimed in claim 10, wherein the pelvic support is an underwear.

16. The beverage-retaining sexual device as claimed in claim 10, wherein the pelvic support is a harness.

17. The beverage-retaining sexual device as claimed in claim 10, wherein the proximal fabric piece and the distal fabric piece are made of a stretchable fabric material.
